(19) United States
(12) Patent Application Publication
(10) Pub. No.: US 2015/0061829 A1
(43) Pub. Date: Mar. 5, 2015

(54) SYSTEM AND METHOD FOR MANAGING FUNCTIONAL FEATURES OF ELECTRONIC DEVICES

(71) Applicant: AT&T Intellectual Property I, LP, Atlanta, GA (US)

(72) Inventors: David Williams, Rowlett, TX (US); Jimmy Epperson, III, Dallas, TX (US)

(73) Assignee: AT&T Intellectual Property I, LP, Atlanta, GA (US)

(21) Appl. No.: 14/018,764

(22) Filed: Sep. 5, 2013

(51) Int. Cl. G07C 9/00

(52) U.S. Cl. CPC G07C 9/00111
USPC 340/5.61

(57) ABSTRACT

A system that incorporates the subject disclosure may include, for example, facilitating an association between an access management device and each of a first and second electronic devices sharing a functional feature. The access management device includes a wireless communication module enabling each of the first and second electronic devices to detect the portable access management device within a respective vicinity of each of the devices. Respectively determining each of the first and second devices is within the vicinity of the access management device is based on presence information provided by the respective device, the presence information being generated by each device responsive to wirelessly communicating with the access management device. The functional feature of the first device is enabled while within the vicinity of the access management device, and the functional feature of the second device is disabled while not within the vicinity. Other embodiments are disclosed.

### FIELD OF THE DISCLOSURE

The subject disclosure relates to a system and method for managing functional features of electronic devices.

### BACKGROUND

Content, data, and computing capabilities are typically stored on various electronic devices, such as tablet computers, smartphones, personal data assistants, laptop computers, media players, and the like. Computing capabilities used on such devices can include software programs including one or more of operating systems, e.g., Android® or iOS® mobile operating systems, application programs (apps) including media players, e.g., iTunes® media player and media library application, web browsers, e.g., Google Chrome® web browser, and messaging services, e.g., Skype® voice-over-IP service and instant messaging client. Such content, data and/or computing capabilities are sometimes synchronized or otherwise downloaded on multiple electronic devices.

According to current trends, content, data, and computing capabilities will be stored, in part or in whole, separately from an underlying electronic device. Such distributed computing environments are sometimes referred to as a cloud, providing network-based services, e.g., real-time network services, that appear to be provided by physical server hardware, which are in fact served up by virtual hardware, e.g., being simulated by software running on one or more real machines. Such virtual servers may not physically exist and can therefore be provisioned, e.g., moved around and scaled up (or down) without affecting the end user. Such cloud services can be supported, e.g., by a distributed set of machines running at different locations, while still connected to a single network or hub service.

Users can access cloud computing environments, e.g., using networked client devices, such as desktop computers, laptops, tablets and smartphones. In at least some instances, the client devices rely on cloud computing for most or substantially all of their applications, so as to be essentially useless without it. Such devices are sometimes referred to as “thin clients,” such as the browser-based Chromebook® computing device.

### BRIEF DESCRIPTION OF THE DRAWINGS

Reference will now be made to the accompanying drawings, which are not necessarily drawn to scale, and wherein:

FIGS. 1A-1B depicts schematic views of an illustrative embodiment of a personal access management system;

FIG. 2 depicts a functional block diagram of an illustrative embodiment of personal access management device illustrated in FIGS. 1A-1B;

FIG. 3 depicts an illustrative embodiment of a process used in portions of the system illustrated in FIGS. 1A-1B;

FIGS. 4-5 depict illustrative embodiments of communication systems that provide media services to devices according to the personal access management system of FIGS. 1A-3;

FIG. 6 depicts an illustrative embodiment of a web portal for interacting with one or more of the personal access management system of FIGS. 1A-3 and the communication systems of FIGS. 4-5;

FIG. 7 depicts an illustrative embodiment of a communication device;

FIG. 8 is a diagrammatic representation of a machine in the form of a computer system within which a set of instructions, when executed, may cause the machine to perform any one or more of the methods described herein; and

FIGS. 9A-9B depict perspective views of wearable embodiments of a personal access management device illustrated in FIGS. 1A-2.

### DETAILED DESCRIPTION

The subject disclosure describes, among other things, illustrative embodiments of systems and processes for determining proximity of electronic devices to a portable access management device and for managing functional features of electronic devices according to the proximity according to one or more rules. Other embodiments are included in the subject disclosure.

One embodiment of the subject disclosure includes a process including facilitating, by a system comprising a processor, an association between a portable access management device and each of a first electronic device and a second electronic device. The portable access management device comprises a radio frequency identifier that enables the first electronic device to detect that the portable access management device is in a vicinity of the first electronic device. The radio frequency identifier enables the second electronic device to detect that the portable access management device is in the vicinity of the second electronic device, wherein the first electronic device and the second electronic device share a functional feature. It is determined that the first electronic device is in the vicinity of the portable access management device based on first presence information provided by the first electronic device to the system. The first presence information is generated by the first electronic device responsive to the first electronic device detecting the radio frequency identifier of the portable access management device. It is determined that the second electronic device is not in the vicinity of the portable access management device responsive to not receiving information from the second electronic device indicating the second electronic device is not in the vicinity of the portable access management device. The functional feature of the first electronic device is enabled responsive to determining the first electronic device is in the vicinity of the portable access management device, and the functional feature of the second electronic device is disabled, while the second electronic device is not in the vicinity of the portable access management device.

Another embodiment of the subject disclosure includes a device, having a memory to store executable instructions and a processor coupled to the memory. The processor, responsive to executing the instructions, performs operations including facilitating an association between a portable access management device and each of a first electronic device and a second electronic device. The portable access management device comprises a radio frequency identifier, wherein the radio frequency identifier enables the first electronic device to detect that the portable access management device is in a vicinity of the first electronic device, wherein the radio frequency identifier enables the second electronic device to detect that the portable access management device is in the vicinity of the second electronic device, wherein the first electronic device and the second electronic device share a functional feature. The processor determines that the first electronic device is in the vicinity of the portable access management device based on first presence information provided by the first electronic device. The first presence information is generated by the first electronic device responsive to the first electronic device detecting the radio frequency identifier of the portable access management device. The processor also determines that the second electronic device is not in the vicinity of the portable access management device responsive to not receiving information from the second electronic device indicating the second electronic device is in the vicinity of the portable access management device. The processor enables the functional feature of the first electronic device responsive to determining the first electronic device is in the vicinity of the portable access management device, and disables the functional feature of the second electronic device while the second electronic device is not in the vicinity of the portable access management device.

Yet another embodiment of the subject disclosure includes a machine-readable storage medium, comprising executable instructions which, responsive to being executed by a processor, cause the processor to perform operations comprising facilitating an association between a portable access management device and each of a first electronic device and a second electronic device. The portable access management device comprises a wireless communication module, wherein the wireless communication module enables the first electronic device to detect that the portable access management device is in a vicinity of the first electronic device. The wireless communication module enables the second electronic device to detect that the portable access management device is in the vicinity of the second electronic device, wherein the first electronic device and the second electronic device share a functional feature. It is determined that the first electronic device is in the vicinity of the portable access management device based on first presence information provided by the first electronic device. The first presence information is generated by the first electronic device responsive to the first electronic device wirelessly communicating with the portable access management device. It is determined that the second electronic device is not in the vicinity of the portable access management device responsive to not receiving information from the second electronic device indicating the second electronic device is not in the vicinity of the portable access management device. The functional feature of the first electronic device is enabled responsive to determining the first electronic device is in the vicinity of the portable access management device. The functional feature of the second electronic device is disabled while the second electronic device is not in the vicinity of the portable access management device.

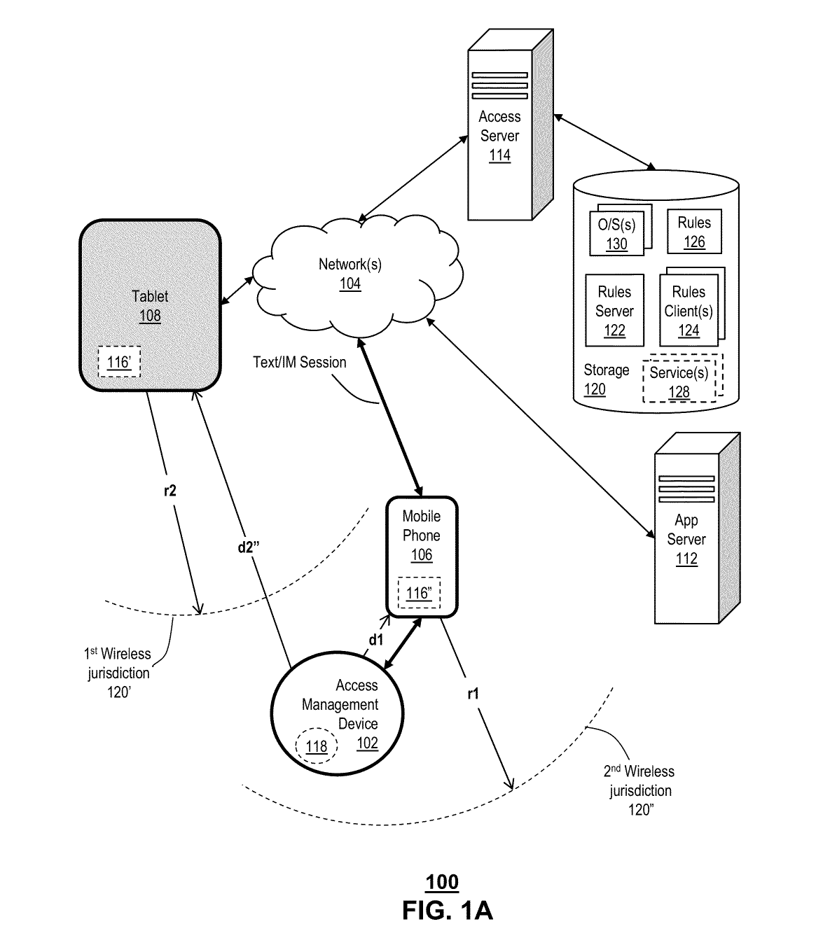

FIG. 1A depicts an illustrative embodiment of a system 100 for managing functional features of electronic devices. The system 100 includes a portable access management device 102 for managing features of electronic devices, such as a mobile phone 106 and a tablet computer 108. More generally, the electronic devices can include, without limitation, a cellular telephone, a cordless telephone, a tablet computer, a portable computer, a desktop computer, a media player, a digital video recorder, a set-top box, a home entertainment system, a home automation system, a security system, an automobile entertainment system, and an automobile navigation system. The system 100 also includes one or more remote computing devices, such as an access management server 114 and, in some instances, one or more application servers 112. Each of the application server 112 and the access server 114 are in communication with one or more of the mobile phone 106, the tablet computer 108 or the portable access management device 102, e.g., through one or more networks 104.

Although a single network 104 is illustrated in the example, it is understood that one or more than one networks can be provided. The networks can be similar or different. For example, one or both of the mobile phone 106 and the tablet computer 108 can connect to one or more of the servers 112, 114 through a WiFi connection to a wireless access point (not shown). Alternatively or in addition, one or both of the mobile phone 106 and the tablet computer 108 can connect to one or more of the servers through a mobile cellular radio network that can be connected to the Internet, e.g., through a wired backbone network accessible to base stations of the mobile cellular radio network.

Each of the electronic devices 106, 108, in turn, includes a respective wireless communication module 116′, 116″ (generally 116). The portable access management device 102 also includes a wireless communication module 118. Wireless communications can be established between any of the devices 106, 108 and the access management device 102 subject to wireless range restrictions. For example, a first wireless jurisdiction 120′ can be identified with respect to the tablet computer 108, indicating a region within which reliable wireless communications with the tablet computer 108 can occur. In the illustrative example, a boundary of a portion of the first wireless jurisdiction 120′ is illustrated by an arc extending to a range “r1” about the tablet computer 108. A second wireless jurisdiction 120″ can be identified with respect to the mobile phone 106. A boundary of a portion of the second wireless jurisdiction 120″ is illustrated by an arc extending to a range “r2” about the mobile phone.

It is understood that in at least some embodiments, the region associated with each of the wireless jurisdictions 120′, 120″ can have different shapes and vary to some degree according to factors, such as the environment. If the local environment about the tablet computer 108 is relatively unobstructed, the shape of the first wireless jurisdiction 120′ can approximate a circle at a range r1, as illustrated. If the local environment, however, includes obstructions, such as walls, furniture, equipment, other persons, either wireless jurisdiction 120′, 120″ can occupy a different, e.g., a non-circular and/or smaller, shape.

In some embodiments, the wireless communication modules 116, 118 are similar. By way of illustrative example, such wireless communication modules 116, 118 can include wireless network modules, e.g., to support wireless network communications between the access management device 102 and the other electronic devices within the wireless jurisdiction 120. Wireless communication modules can include one or more of radio communication modules, e.g., IEEE 802.11 (e.g., WiFi), IEEE 802.15 (e.g., Bluetooth), and ETSI HiperPAN. Other types of wireless communication modules can support one or more of Infrared, e.g., Infrared Data Association (IrDA), optical, e.g., bar code reader, acoustic, and inductive, e.g., near-field communication (NFC), e.g., magnetic induction. In some embodiments, the wireless jurisdiction can be controlled, e.g., by adjusting a corresponding power level of the wireless communication signals, such as power class dependent Bluetooth, which can be adjusted from about a 1 meter range to about a 10 meter ranger, or greater.

A determination as to whether an electronic device, e.g., the tablet computer 108 and/or the mobile phone 106, is beyond a limited range of wireless communications, e.g., with the portable access management device 102, can include measuring a strength, e.g., power, of a wireless signal transmitted by a transmitter unit of one of the communication modules 116, 118. A determination that the control unit is beyond the limited range of wireless communications can be made if the measured signal strength is below a predetermined level or threshold. The predetermined threshold can correspond to a certain distance. In at least some embodiments, the particular threshold that is compared against the received signal strength can be one of many thresholds selected by a user at the control unit. The particular threshold can also vary according to the electronic device, such that the tablet computer 108 and mobile phone 106 can have a different distance than other electronic devices, such as a home entertainment or security system. For example, the control unit can store two or more predetermined thresholds corresponding to a short range, e.g., in a personal space within about 1-2 meters, or within reach, and an extended range, e.g., within about 3-10 meters, for example, within a room or a building. A user may select one of the predetermined levels as default threshold and/or a device-specific threshold.

In at least some embodiments, the wireless modules implement wireless communications generally referred to as radio-frequency identification (RFID). In the illustrative example, the wireless communication module 118 of the portable access management device 102 includes a transponder, such as an RFID tag. The RFID tag can be programmed or otherwise configured to provide a wireless signal including identifying information that can be used to identify, in this instance, the portable access management device 102. The wireless signal of the RFID tag 118 can be initiated or otherwise stimulated by a wireless interrogator. According to the illustrative example, the wireless communication module 116′, 116″ of each of the tablet computer 108 and the mobile phone 106 includes a respective RFID interrogator. The interrogators 116 can be programmed or otherwise configured to transmit a wireless interrogation signal causing the RFID tags, e.g., RFID tag 118, to produce a wireless response when the portable access management device is within a respective one of the first and second wireless jurisdictions 120′, 120″. The interrogator 116 can also be configured to receive the wireless response signal from the RFID tab 118 and to interpret the signal in order to determine or otherwise identify a source of the signal, e.g., the portable access management device 102.

Although the illustrative example refers to an RFID tag 118 at the portable management device 102 and RFID interrogators 116′, 116″ at the tablet computer 108 and the mobile phone 106, it is conceivable that the roles could be reversed. Namely, the wireless communication module 118 of the portable access management device 102 can include a wireless RFID interrogator; whereas, each of the tablet computer 108 and the mobile phone 106 can include a respective wireless RFID transponder or tag 116′, 116″. Transponders, such as the RFID tags disclosed herein, can include passive tags, active tags and/or battery assisted passive tags. An active tag can include an on-board battery that can be configured, in at least some instances, to periodically transmits its identification (ID) signal. A battery assisted passive tag has a small battery on board and can be activated when in the presence of a RFID interrogator, or reader. A passive tag does not include a battery, instead using energy obtained from another source, such as the interrogation signal, to produce a wireless response signal. RFID Tags can be integrated into the electronic devices, e.g., during manufacture, or applied during a retrofit procedure. In at least some embodiments, incorporating an RFID tag to an electronic device can be as simple as affixing the RFID tag to a surface of the electronic device, e.g., using an adhesive or other suitable fastener.

As illustrated in FIG. 1A, the portable access management device 102 is within the second wireless jurisdiction of the mobile phone's RFID interrogator 116″. Thus, the mobile phone 106 can detect that it is within a local vicinity of the access management device 102. Namely, a separation distance d1 between the devices 102, 106 is less than the range r1 of the second wireless jurisdiction 120″. The portable access management device 102; however, is not located within the first wireless jurisdiction of the tablet computer's RFID interrogator 116′, as a separation distance d2 between the devices 102, 108 is greater than the range r2 of the first wireless jurisdiction 120′. Accordingly, the tablet computer 108 cannot detect that it is within a local vicinity of the access management device 102, supporting a conclusion that it is outside of the second wireless jurisdiction, or otherwise not proximate or otherwise present in the vicinity of the access management device.

Continuing with the illustrative example, the mobile phone 106, determined to be within the vicinity of the portable access management device 102, and by extension a user, is engaged in a message session with a remote user (not shown), e.g., using a messaging service, such as a short message service (SMS) and/or an instant message service, such as Skype® messaging service. On the other hand, the tablet computer 108, determined to be away from the portable access management device 102 is not engaged in a message session with the remote user.

The particular configuration, e.g., relative locations, of the electronic devices 106, 108, the portable access management device 102 and the service(s), e.g., messaging, available or unavailable at the electronic devices 106, 108, can be generally referred to as an access management state. The access management state can vary, e.g., according to relative movement or reconfiguration of one or more of the electronic devices 106, 108 and/or the access management device 102, and/or according to changes in features of the electronic devices, including shared features, such as delivered service(s), e.g., messaging.

An example of a reconfigured access management state is illustrated in FIG. 1B. In the re-configures state, the mobile phone 106, separated by a distance d1 that is less than the range r1 of the second wireless jurisdiction 120″, determined to be within the vicinity of the portable access management device 102. The mobile phone 106, however, is not engaged in a message session, because the tablet computer 108 is also determined to be within the vicinity of the portable access management device 102—a separation distance d2 between devices being less than the first wireless jurisdiction range r1. A determination whether the shared feature, e.g., message service is delivered, supported or otherwise presented to the mobile phone 106 and/or the tablet computer 108 when the portable access management device 102 is within wireless jurisdiction of both devices 106, 108 can be established or otherwise controlled by a rule. Such rules can embody a user preference, or a network service provider recommendation for an orderly delivery of services depending upon the access management state, e.g., the proximity of electronic devices 106, 108 to the access management device 102, and by extension, to the user.

Rules related to the allocation of shared features among different electronic devices can be established as a default, e.g., according to rules prescribed by a network services provider. Alternatively or in addition, one or more rules can be prescribed or otherwise configured by a user, e.g., being stored or otherwise associated with a user profile. For example, the access server 114 can provide service(s) to implement access management services disclosed herein. According to the illustrative example, the access server 114 is in electrical communication with one or more storage service(s) 120. The storage service(s) 120 can be physical storage collocated with the access server 114, network accessible storage (cloud storage) or some combination of both. In some embodiments, the access server 114 can be configured to implement a rules service 122 that cooperated with one or more rules clients 124. For example, each of the electronic devices 106, 108 can have an associated rules client 124 that can be configured independently or in cooperation with each other. Alternatively or in addition, the portable access management device 102 can have an associated rules client 124 that can be configured with respect to one or more electronic devices, such as the mobile phone 106 and the tablet computer 108.

One or more rule(s) 126, whether pre-configured, e.g., by the services provider, and/or configured by a user can be stored, e.g., in the storage 120 associated with the access server 114. It is also conceivable that one or more additional services 128, including operating system services 130 can be provided by the access server, e.g., according to the principles of cloud computing. It should also be understood that although a single access server 114 and a single storage 120 facility are illustrated, it is possible that either device 114, 120 can be provided by more than one physical devices, virtual devices, or some combination of physical or virtual devices, e.g., according to the principles of cloud computing.

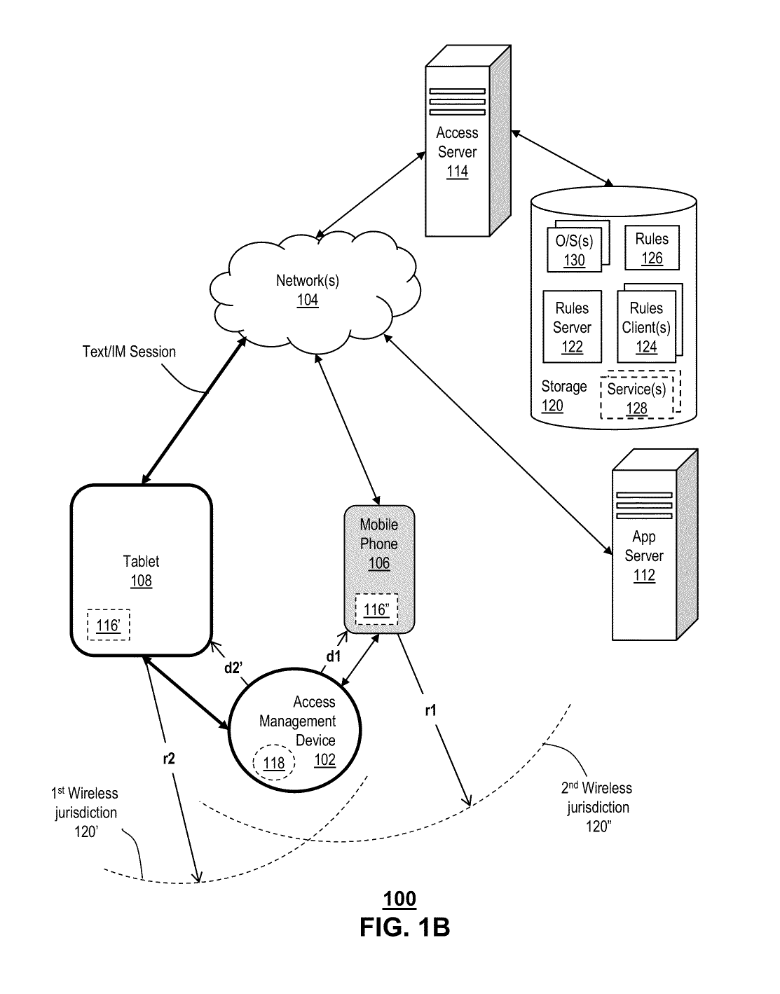

FIG. 2 depicts an illustrative embodiment of an access management device 200. The access management device includes a wireless communication module 202 that can be used in a determination of whether the access management device 200 is within a vicinity, e.g., within a respective wireless jurisdiction, of one or more electronic devices. The wireless communication module 202 can operate according to any of the wireless technologies disclosed herein or otherwise generally known. In a particular embodiment, the wireless communication module implements radio communications, e.g., RFID. In some embodiments, the wireless communication module 202 comprises a transponder 206 (shown in phantom) configured to receive an identification, e.g., from an identifier module 202 (shown in phantom). The identifier module 204 can be integrated with the wireless communication module 202, e.g., in a single transponder 206 or RFID tag. In such a configuration, the transponder 206 generates a wireless signal including indicia of the identifier. The wireless signal can be generated periodically, e.g., as in a heartbeat, in response to an event, e.g., movement of the device (the access management device 200 can include a motion sensor to detect movement), in response to an interrogation signal, e.g., from an RFID interrogator or reader (not shown), or a combination of both. Alternatively or in addition, the wireless communication module 202 can include an interrogator or RFID reader adapted to interrogate RFID tags of other electronic devices.

It is understood that the access management device 200 can have any one of a variety of different configurations. For example, the access management device 200 can include a housing 207 to which the wireless communication module 202, e.g., the transponder 206 is attached. The housing 207 can be fashioned in a variety of configurations, e.g., generally suitable to portability and comfort to a user. For example, and without limitation, the housing can include a mounting bracket, such as a pin, a clasp, a hook, a loop. The housing 207 itself can be fashioned to support mounting or wearability by the user. Some examples include a wristband, a ring, a necklace, an attachment to a chain, e.g., to a necklace, a belt, a cap, a shoe, a garment, such as a vest, a shirt, pants, a jacket or sweater. Alternatively or in addition, the housing 207 can be configured for ease of portability by the user. Some examples include a card configuration, e.g., a credit card, suitable for carrying in a wallet or purse, a key chain or key fob, a briefcase, a purse, an umbrella, or other such accessory.

In some configurations the access management device 200 includes little or no more than the housing 207 and the wireless communication module 202 or transponder 206, e.g., RFID tag. Alternatively or in addition, the access management device can include one or more other components, such as a power source 106, a processor 208, a memory 212, a user interface 210 or a network interface 216. The processor can be a sophisticated processor, e.g., to support one or more applications hosted locally or clients for remote applications. Alternatively or in addition, the processor 208 can include a “thin client,” otherwise relying, at least in part, on remote resources for processing.

In at least some embodiments, the network interface 214 can be used to access remote applications, processing, and or storage resources, e.g., in support of a “thin client” processor 208. For example the network interface 214 can access one or more of a wireless access point (e.g., WiFi) and a cellular mobile radio network (e.g., a local cell site including a femtocell). Alternatively or in addition, the network interface 214 can access such wireless access points or cell sites through one or more of any electronic devices within a vicinity of the access management device 200. For example, the access management device 200 can communication with a nearby electronic device by an suitable communication means, such as 802.11 (e.g., WiFi), 802.15 (e.g., Bluetooth) or some other proprietary communication protocol. It is also understood that in at least some embodiments, the wireless communication module 202 can also serve as means for accessing a network.

The user interface 210, when provided, can be a sophisticated interface, e.g., a display, a touchscreen, a keyboard, or a more simplistic interface, such as a touch or swipe pad, button, or array of buttons. The memory 212 can include any suitable electronic storage, e.g., random access memory, flash memory, electronic memory, magnetic disk, optical disk, and the like. The power source 216 can include any suitable power source, such as a replaceable battery, a rechargeable battery, a capacitive device, an adapter or interface to an external power source, such as facility power. In at least some embodiments an energy harvesting power source 216 can included or otherwise accompany any of the other power sources disclosed herein. Some examples of energy harvesting power sources include known devices to harvest light, e.g., solar energy, ambient radio frequency energy, thermal energy (e.g., body heat), acoustic energy, kinetic energy and the like.

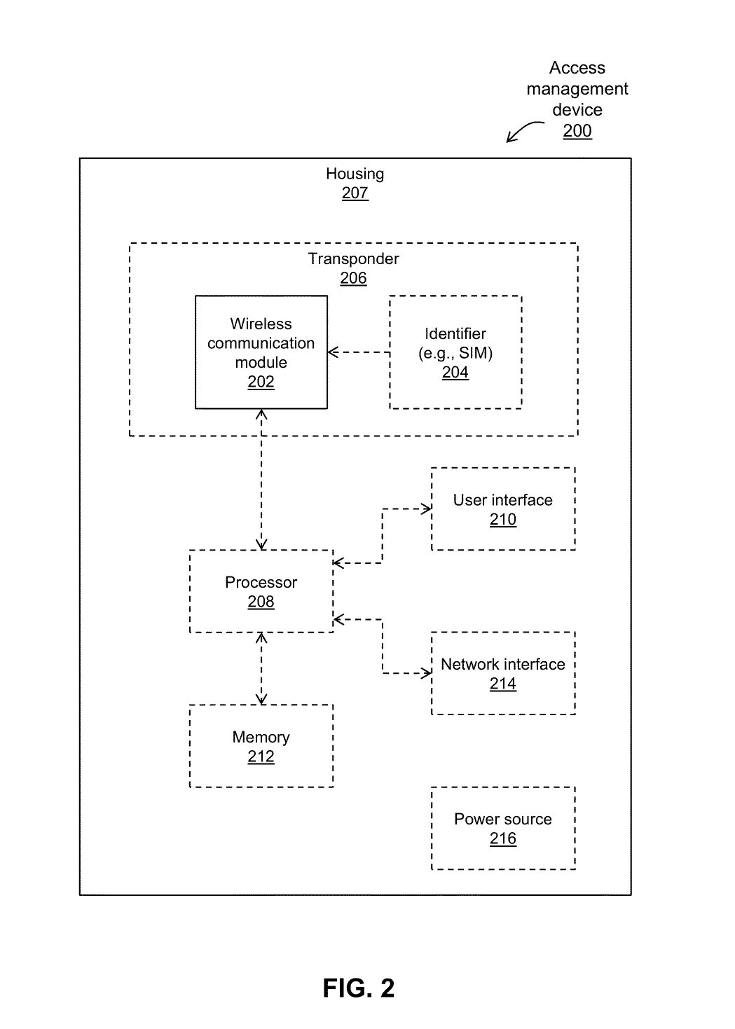

FIG. 3 depicts an illustrative embodiment of a process used by the system illustrated in FIGS. 1A-1B. Namely, the process determines proximity of electronic devices to a portable access management device and manages functional features of electronic devices according to the proximity and according to one or more rules. An association between a portable access management device and one or more electronic devices is facilitated at 302.

Proximity of a first electronic device within a vicinity of a portable access management device is determined at 304. As disclosed in relation to FIGS. 1A-B, proximity within the vicinity of the portable access management device 102 is determined according to the access management device being within a wireless jurisdiction 120′ of a first electronic device, e.g., the mobile phone 106. According to the illustrative examples provided herein, the portable access management device 102 comprises a radio frequency identifier 118, e.g., an RFID tag. The radio frequency identifier, or tag 118, enables the first electronic device 106 to detect that the portable access management device 102 is within a vicinity of the first electronic device 106. For example, first presence information can be generated by the first electronic device 106 responsive to the first electronic device 106 detecting, e.g., by way of an RFID interrogator, the radio frequency identifier, e.g., RFID tag 118 of the portable access management device 102. Presence information can be provided by the first electronic device 106 to the system 100, e.g., the access management server 114 allowing the access management server 114 to determine or otherwise conclude proximity of the portable access management device 102 and the first electronic device 106.

In at least some embodiments the system, e.g., the access management server 114, maintains an access management state. Having determined that the portable access management device 102 is proximate to the first electronic device, the access management state is updated at 306. If this is the first device detected, the access management state can indicate information related to the device, a device type or category, e.g., mobile phone, a brand, e.g., Apple®, a model, e.g., iPhone 5.1, and the like. The access management state might also include additional information, e.g., obtained from a database or similar association table for the identified device. Such information can also include capabilities, such as a version of operating system, device specific features (e.g., camera, GPS, screen size/resolution, radio type, bandwidth, data rate, owner, carrier, etc.) Such information can be keyed to a device identification, e.g., obtained from an equipment identification number (EIN), a subscriber identification module (SIM), a user and/or system prescribed label, and the like.

A determination is made at 308 whether any other electronic devices are proximate to the portable application management device 102. For example, a second electronic device, e.g., the tablet computer 108 interrogates the transponder 118 of the portable access management device 118. To the extent a reliable reply to the interrogation is received, e.g., at the second electronic device 108, the interrogation results are provided to the system 100, e.g., to the access management server 114. The access management server 114 can determine beforehand, e.g., according to the association at 302, which devices are within a set of electronic devices to be discovered. For example, the access management server 114 can poll each of the associated devices, in turn, obtaining results from each device as to whether it is proximate to the portable access management device 102. To the extent any other devices, e.g., the second electronic device 108, are discovered, the access management state is further updated at 306.

Once the access management state has been determined, e.g., that there are no other devices to poll at 308, one or more features of the associated devices are enabled and/or disabled. Whether a particular device is enabled or disabled can depend on whether the device is proximate to the portable access management device 102 (e.g., enabling or disabling the device), not proximate to the portable access management device 102 (e.g., enabling or disabling the device). Some examples of devices that can be disabled when not proximate to the access management device 102 include a mobile phone, automobile system(s), a tablet device. Some examples of devices that can be enabled when not proximate to the access management device 102 include security system services (e.g., a home security system), environmental system services (e.g., activating/deactivating lighting, heating, cooling).

In the illustrative example of FIGS. 1A and 1B, the access management state identifies the first device, e.g., the mobile phone 106 as being proximate to the access management device 102; whereas, the second device, e.g., the tablet computer 108 is identified as being remote. In response to determining that only the first 106 and not the second electronic device 108 is not in the vicinity of the portable access management device 102, a functional feature of the mobile phone 106, e.g., messaging service, is activated; whereas, the same functional feature of the tablet computer 108 is disabled. Although the example describes management of a shared feature, e.g., messaging, it is understood that configuration of different features of the respective devices 106, 108 can be enabled, disabled, or otherwise modified according to the access management state.

In at least some embodiments, a user and/or a network service provider can choose to initiate a change in associated devices at 312. To the extent it is determined at 312 that changes to the associated devices should be made, e.g., to add and/or remove one or more electronic devices, the process continues at 302. To the extent it is determined at 312 that changes to the associated devices are not necessary, the process continues. A determination is made at 314 whether any of the associated electronic devices, e.g., the mobile phone 106 and/or the tablet computer 108, are proximate to the access management device 102. This can be accomplished, for example, by initiating a polling of the associated devices 106, 108 at 314. Initiation of such a polling can occur responsive to a schedule, e.g., periodic, e.g., every minute, five minutes, hour, and so forth. Alternatively or in addition, initiation of such polling can be tied to an event, e.g., movement of one or more of the devices (e.g., according to the devices motion sensor and/or GPS locator), and/or to a user action, such as selecting a button on one of the electronic devices, the access management device, or at a portal or similar facility.

When more than two devices share a functional feature, e.g., voice communications, message service, streaming media, one or more rules can be established, e.g., to enable or disable functional features at 310 depending on determination of presence of multiple devices proximate to the access management device 102.

Continuing with the illustrative example of FIGS. 1A and 1B, an initial access management state was determined at 306 identifying only the mobile phone 106 as being proximate to the access management device 102, the tablet computer 108 having been identified as being remote. At a later time a relative distance between the tablet computer 108 and the access management device 102 falls within the radio jurisdiction 120′ of the second device 108. The change in configuration is determined at 314, with the particular change in proximate devices being obtained at 316. According to the change, both the first and second electronic devices are proximate to the access management device. To the extent changes are identified at 316, the functional features of the devices 106, 108 are enabled, disabled and/or modified at 310. To the extent changes are not identified at 316, the a determination is made, again, at 312 whether there are any changes to the associated devices and a determination regarding presence of associated devices determined at 314.

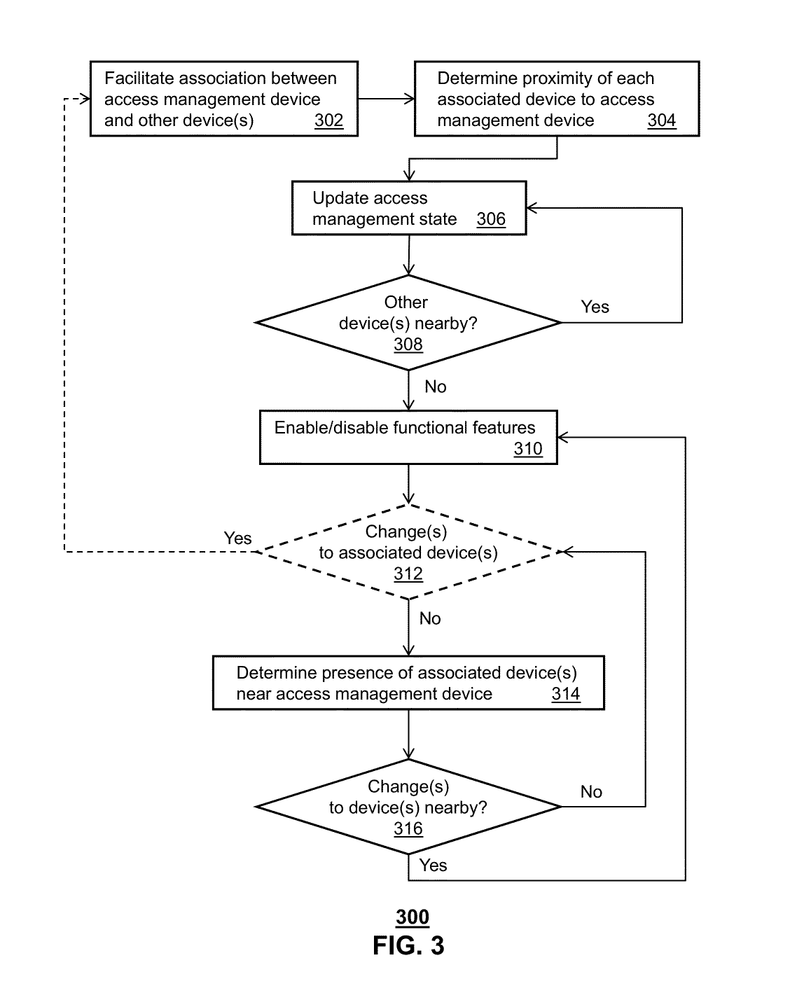

FIG. 4 depicts an illustrative embodiment of a first communication system 400 for delivering media content. The communication system 400 can represent an Internet Protocol Television (IPTV) media system. Communication system 400 can be overlaid or operably coupled with a system for determining proximity of electronic devices to a portable access management device and for managing functional features of electronic devices according to the proximity according to one or more rules as illustrated in FIGS. 1A-B and 3 as another representative embodiment of communication system 400. For example, a portable access management device 452 can be associated with one or more other devices, such as media processors gateway processors, computers, mobile phones, and the like. Presence, e.g., being near a user carrying or otherwise wearing the portable access management device 452, is determined according to proximity of the devices to the portable access management device 452. One or more server 430 can be configured to implement access management services, e.g., recording associated devices, receiving indications of proximity of associated devices to the portable access management device 452, e.g., the user, and implementing rules, e.g., to enable and/or disable one or more functional feature(s) on each of the associated devices.

The IPTV media system can include a super head-end office (SHO) 410 with at least one super headend office server (SHS) 411 which receives media content from satellite and/or terrestrial communication systems. In the present context, media content can represent, for example, audio content, moving image content such as 2D or 3D videos, video games, virtual reality content, still image content, and combinations thereof. The SHS server 411 can forward packets associated with the media content to one or more video head-end servers (VHS) 414 via a network of video head-end offices (VHO) 412 according to a multicast communication protocol.

The VHS 414 can distribute multimedia broadcast content via an access network 418 to commercial and/or residential buildings 402 housing a gateway 404 (such as a residential or commercial gateway). The access network 418 can represent a group of digital subscriber line access multiplexers (DSLAMs) located in a central office or a service area interface that provide broadband services over fiber optical links or copper twisted pairs 419 to buildings 402. The gateway 404 can use communication technology to distribute broadcast signals to media processors 406 such as Set-Top Boxes (STBs) which in turn present broadcast channels to media devices 408 such as computers or television sets managed in some instances by a media controller 407 (such as an infrared or RF remote controller).

The gateway 404, the media processors 406, and media devices 408 can utilize tethered communication technologies (such as coaxial, powerline or phone line wiring) or can operate over a wireless access protocol such as Wireless Fidelity (WiFi), Bluetooth, Zigbee, or other present or next generation local or personal area wireless network technologies. By way of these interfaces, unicast communications can also be invoked between the media processors 406 and subsystems of the IPTV media system for services such as video-on-demand (VoD), browsing an electronic programming guide (EPG), or other infrastructure services.

A satellite broadcast television system 429 can be used in the media system of FIG. 4. The satellite broadcast television system can be overlaid, operably coupled with, or replace the IPTV system as another representative embodiment of communication system 400. In this embodiment, signals transmitted by a satellite 415 that include media content can be received by a satellite dish receiver 431 coupled to the building 402. Modulated signals received by the satellite dish receiver 431 can be transferred to the media processors 406 for demodulating, decoding, encoding, and/or distributing broadcast channels to the media devices 408. The media processors 406 can be equipped with a broadband port to an Internet Service Provider (ISP) network 432 to enable interactive services such as VoD and EPG as described above.

In yet another embodiment, an analog or digital cable broadcast distribution system such as cable TV system 433 can be overlaid, operably coupled with, or replace the IPTV system and/or the satellite TV system as another representative embodiment of communication system 400. In this embodiment, the cable TV system 433 can also provide Internet, telephony, and interactive media services.

The subject disclosure can apply to other present or next generation over-the-air and/or landline media content services system.

Some of the network elements of the IPTV media system can be coupled to one or more computing devices 430, a portion of which can operate as a web server for providing web portal services over the ISP network 432 to wireline media devices 408 or wireless communication devices 416. As indicated above, one or more of the servers 430 can implement alone or in combination with other devices, e.g., other servers, the associated electronic devices, or the portable access management device, an access management service to control or otherwise adjust functional features of associated electronic devices according to the proximity of the electronic devices to the portable electronic access device 452, e.g., the user.

Communication system 400 can also provide for all or a portion of the computing devices 430 to function as an access management server (herein referred to as access management server 430). The access management server 430 can use computing and communication technology to perform function 462, which can include among other things, determining proximity of electronic devices to the portable access management device 452 and/or implementing rules, e.g., to enable, disable and/or modify functional features among associated devices according to the determined proximity. The media processors 406 and wireless communication devices 416 can be provisioned with software functions 464 and 466, e.g., to detect nearby devices, e.g., using RFID techniques, to implement rules, e.g., enabling, disabling, or modifying functional features of the electronic devices and, respectively, to utilize the services of the access management server 430.

Multiple forms of media services can be offered to media devices over landline technologies such as those described above. Additionally, media services can be offered to media devices by way of a wireless access base station 417 operating according to common wireless access protocols such as Global System for Mobile or GSM, Code Division Multiple Access or CDMA, Time Division Multiple Access or TDMA, Universal Mobile Telecommunications or UMTS, World interoperability for Microwave or WiMAX, Software Defined Radio or SDR, Long Term Evolution or LTE, and so on. Other present and next generation wide area wireless access network technologies can be used in one or more embodiments of the subject disclosure.

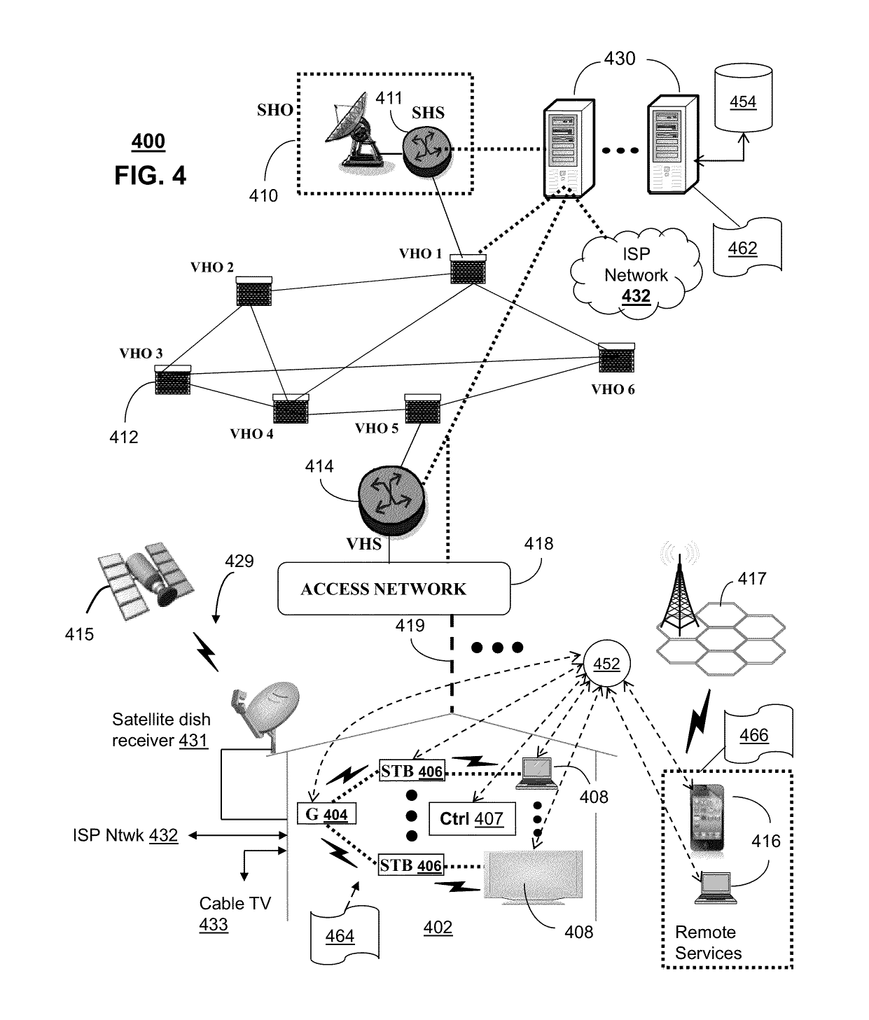

FIG. 5 depicts an illustrative embodiment of a communication system 500 employing an IP Multimedia Subsystem (IMS) network architecture to facilitate the combined services of circuit-switched and packet-switched systems. Communication system 500 can be overlaid or operably coupled with a system for determining proximity of electronic devices to a portable access management device and for managing functional features of electronic devices according to the proximity according to one or more rules as illustrated in FIGS. 1A-3 and communication system 400 as another representative embodiment of communication system 400. For example, a portable access management device 552 can be associated with one or more other devices, such as cordless phones, landline phones, mobile phones, and the like. A presence, e.g., near a user carrying or otherwise wearing the portable access management device 552, is determined according to proximity of the devices to the portable access management device 552. One or more servers 430 can be configured to implement access management services, e.g., recording associated devices, receiving indications of proximity of associated devices to the portable access management device 552, e.g., the user, and implementing rules, e.g., to enable and/or disable one or more functional feature(s) on each of the associated devices.

Communication system 500 can comprise a Home Subscriber Server (HSS) 540, a tElephone NUmber Mapping (ENUM) server 530, and other network elements of an IMS network 550. The IMS network 550 can establish communications between IMS-compliant communication devices (CDs) 501, 502, Public Switched Telephone Network (PSTN) CDs 503, 505, and combinations thereof by way of a Media Gateway Control Function (MGCF) 520 coupled to a PSTN network 560. The MGCF 520 need not be used when a communication session involves IMS CD to IMS CD communications. A communication session involving at least one PSTN CD may utilize the MGCF 520.

IMS CDs 501, 502 can register with the IMS network 550 by contacting a Proxy Call Session Control Function (P-CSCF) which communicates with an interrogating CSCF (I-CSCF), which in turn, communicates with a Serving CSCF (S-CSCF) to register the CDs with the HSS 540. To initiate a communication session between CDs, an originating IMS CD 501 can submit a Session Initiation Protocol (SIP INVITE) message to an originating P-CSCF 504 which communicates with a corresponding originating S-CSCF 506. The originating S-CSCF 506 can submit the SIP INVITE message to one or more application servers (ASs) 517 that can provide a variety of services to IMS subscribers.

For example, the application servers 517 can be used to perform originating call feature treatment functions on the calling party number received by the originating S-CSCF 506 in the SIP INVITE message. Originating treatment functions can include determining whether the calling party number has international calling services, call ID blocking, calling name blocking, 7-digit dialing, and/or is requesting special telephony features (e.g., *72 forward calls, *73 cancel call forwarding, *67 for caller ID blocking, and so on). Based on initial filter criteria (iFCs) in a subscriber profile associated with a CD, one or more application servers may be invoked to provide various call originating feature services.

Additionally, the originating S-CSCF 506 can submit queries to the ENUM system 530 to translate an E.164 telephone number in the SIP INVITE message to a SIP Uniform Resource Identifier (URI) if the terminating communication device is IMS-compliant. The SIP URI can be used by an Interrogating CSCF (I-CSCF) 507 to submit a query to the HSS 540 to identify a terminating S-CSCF 514 associated with a terminating IMS CD such as reference 502. Once identified, the I-CSCF 507 can submit the SIP INVITE message to the terminating S-CSCF 514. The terminating S-CSCF 514 can then identify a terminating P-CSCF 516 associated with the terminating CD 502. The P-CSCF 516 may then signal the CD 502 to establish Voice over Internet Protocol (VoIP) communication services, thereby enabling the calling and called parties to engage in voice and/or data communications. Based on the iFCs in the subscriber profile, one or more application servers may be invoked to provide various call terminating feature services, such as call forwarding, do not disturb, music tones, simultaneous ringing, sequential ringing, etc.

In some instances the aforementioned communication process is symmetrical. Accordingly, the terms “originating” and “terminating” in FIG. 5 may be interchangeable. It is further noted that communication system 500 can be adapted to support video conferencing. In addition, communication system 500 can be adapted to provide the IMS CDs 501, 502 with the multimedia and Internet services of communication system 400 of FIG. 4.

If the terminating communication device is instead a PSTN CD such as CD 503 or CD 505 (in instances where the cellular phone only supports circuit-switched voice communications), the ENUM system 530 can respond with an unsuccessful address resolution which can cause the originating S-CSCF 506 to forward the call to the MGCF 520 via a Breakout Gateway Control Function (BGCF) 519. The MGCF 520 can then initiate the call to the terminating PSTN CD over the PSTN network 560 to enable the calling and called parties to engage in voice and/or data communications.

It is further appreciated that the CDs of FIG. 5 can operate as wireline or wireless devices. For example, the CDs of FIG. 5 can be communicatively coupled to a cellular base station 521, a femtocell, a WiFi router, a Digital Enhanced Cordless Telecommunications (DECT) base unit, or another suitable wireless access unit to establish communications with the IMS network 550 of FIG. 5. The cellular access base station 521 can operate according to common wireless access protocols such as GSM, CDMA, TDMA, UMTS, WiMax, SDR, LTE, and so on. Other present and next generation wireless network technologies can be used by one or more embodiments of the subject disclosure. Accordingly, multiple wireline and wireless communication technologies can be used by the CDs of FIG. 5.

Cellular phones supporting LTE can support packet-switched voice and packet-switched data communications and thus may operate as IMS-compliant mobile devices. In this embodiment, the cellular base station 521 may communicate directly with the IMS network 550 as shown by the arrow connecting the cellular base station 521 and the P-CSCF 516.

Alternative forms of a CSCF can operate in a device, system, component, or other form of centralized or distributed hardware and/or software. Indeed, a respective CSCF may be embodied as a respective CSCF system having one or more computers or servers, either centralized or distributed, where each computer or server may be configured to perform or provide, in whole or in part, any method, step, or functionality described herein in accordance with a respective CSCF. Likewise, other functions, servers and computers described herein, including but not limited to, the HSS, the ENUM server, the BGCF, and the MGCF, can be embodied in a respective system having one or more computers or servers, either centralized or distributed, where each computer or server may be configured to perform or provide, in whole or in part, any method, step, or functionality described herein in accordance with a respective function, server, or computer.

The access management server 430 of FIG. 4 can be operably coupled to the second communication system 500 for purposes similar to those described above. The access management server 430 can perform function 462 and thereby provide access management services to the CDs 501, 502, 503 and 505 of FIG. 5. CDs 501, 502, 503 and 505, which can be adapted with software to perform function 572 to utilize the services of the access management server 430. The access management server 430 can be an integral part of the application server(s) 517 performing function 574, which can be substantially similar to function 462 and adapted to the operations of the IMS network 550.

For illustration purposes only, the terms S-CSCF, P-CSCF, I-CSCF, and so on, can be server devices, but may be referred to in the subject disclosure without the word “server.” It is also understood that any form of a CSCF server can operate in a device, system, component, or other form of centralized or distributed hardware and software. It is further noted that these terms and other terms such as DIAMETER commands are terms can include features, methodologies, and/or fields that may be described in whole or in part by standards bodies such as ^{3rd} Generation Partnership Project (3GPP). It is further noted that some or all embodiments of the subject disclosure may in whole or in part modify, supplement, or otherwise supersede final or proposed standards published and promulgated by 3GPP.

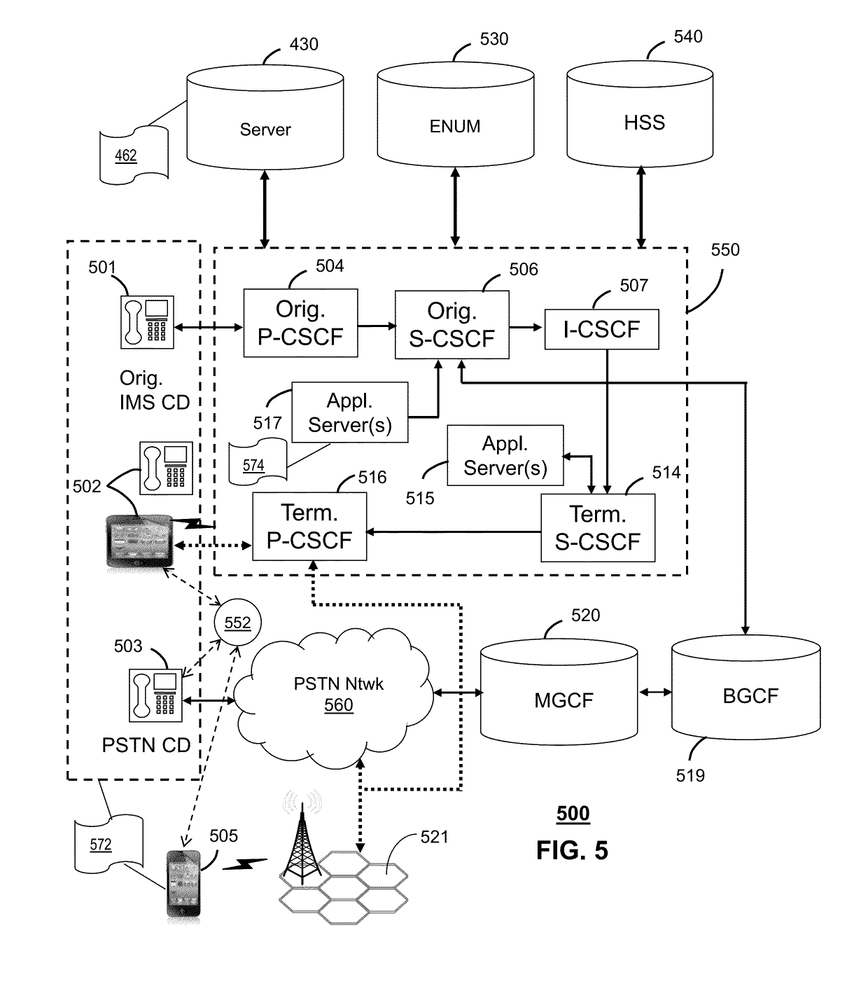

FIG. 6 depicts an illustrative embodiment of a web portal 602 which can be hosted by server applications operating from the computing devices 430 of the communication system 400 illustrated in FIG. 4. Communication system 600 can be overlaid or operably coupled with the access management system 100, the communication system 400, and/or the communication system 500 as another representative embodiment of the system of FIGS. 1A-B, communication 400, and/or communication system 500. For example, a portable access management device 652 can be associated with one or more other devices, such as media processors gateway processors, computers, mobile phones, and the like. Presence, e.g., being near a user carrying or otherwise wearing the portable access management device 452, is determined according to proximity of the devices to the portable access management device 452. One or more servers 430 can be configured to implement access management services, e.g., recording associated devices, receiving indications of proximity of associated devices to the portable access management device 452, e.g., the user, and implementing rules, e.g., to enable and/or disable one or more functional feature(s) on each of the associated devices. The web portal 602 can be used for managing services of one or more of the access management system 100 or the communication systems 400-500. A web page of the web portal 602 can be accessed by a Uniform Resource Locator (URL) with an Internet browser such as Microsoft's Internet Explorer™, Mozilla's Firefox™, Apple's Safari™, or Google's Chrome™ using an Internet-capable communication device such as those described in FIGS. 1-2. The web portal 602 can be configured, for example, to access a media processor 106 and services managed thereby such as a Digital Video Recorder (DVR), a Video on Demand (VoD) catalog, an Electronic Programming Guide (EPG), or a personal catalog (such as personal videos, pictures, audio recordings, etc.) stored at the media processor 106. The web portal 602 can also be used for provisioning IMS services described earlier, provisioning Internet services, provisioning cellular phone services, and so on.

The web portal 602 can further be utilized to manage and provision software applications 462-466, and 572-574 to adapt these applications as may be desired by subscribers and service providers of communication systems 400-500.

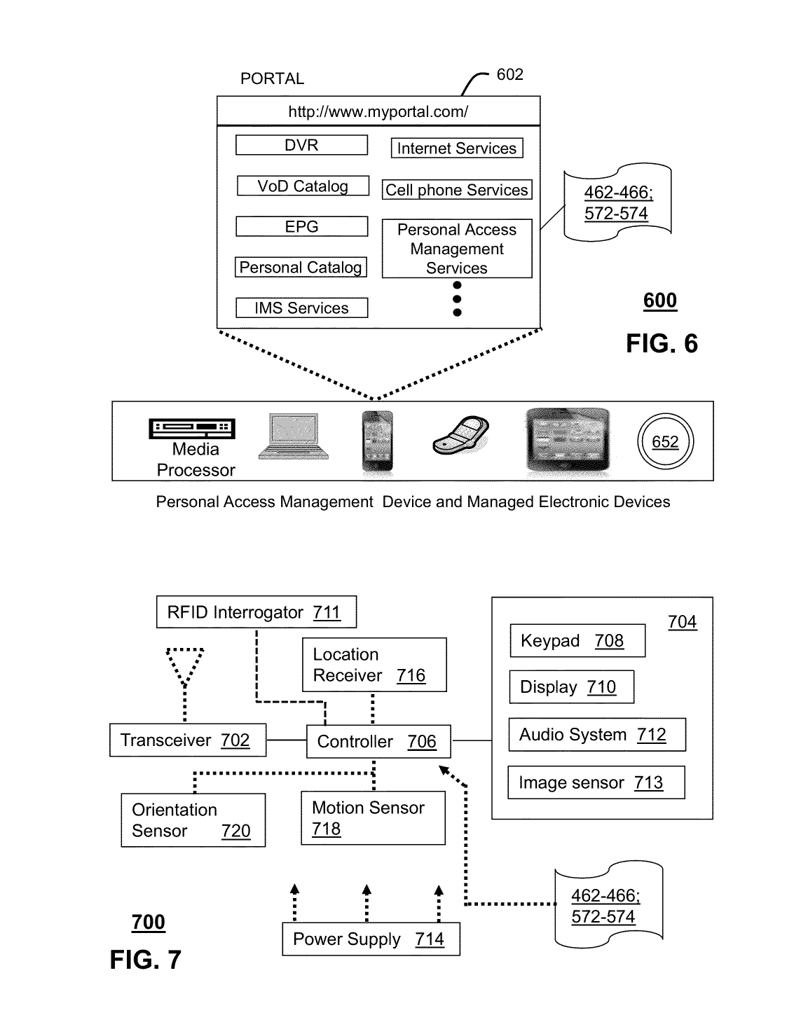

FIG. 7 depicts an illustrative embodiment of a communication device 700. Communication device 700 can serve in whole or in part as an illustrative embodiment of the devices depicted in FIGS. 4-5. For example, a portable access management device 452 (FIG. 4) can be associated with one or more other devices, including communication devices, such as a mobile phone 106, a tablet computer 108 (FIG. 1A) and the like. Presence, e.g., being near a user carrying or otherwise wearing the portable access management device 452, is determined according to proximity of the devices to the portable access management device 452. One or more servers 430 can be configured to implement access management services, e.g., recording associated devices, receiving indications of proximity of associated devices to the portable access management device 452, e.g., the user, and implementing rules, e.g., to enable and/or disable one or more functional feature(s) on each of the associated devices.

To enable these features, communication device 700 can comprise an RFID interrogator 711, a wireline and/or wireless transceiver 702 (herein transceiver 702), a user interface (UI) 704, a wireless communication module, e.g., a power supply 714, a location receiver 716, a motion sensor 718, an orientation sensor 720, and a controller 706 for managing operations thereof. The RFID interrogator 711 can determine proximity to an RFID tag equipped device, such as the portable access management device 452. The transceiver 702 can support short-range or long-range wireless access technologies such as Bluetooth, ZigBee, WiFi, DECT, or cellular communication technologies, just to mention a few. Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 702 can also be adapted to support circuit-switched wireline access technologies (such as PSTN), packet-switched wireline access technologies (such as TCP/IP, VoIP, etc.), and combinations thereof.

The UI 704 can include a depressible or touch-sensitive keypad 708 with a navigation mechanism such as a roller ball, a joystick, a mouse, or a navigation disk for manipulating operations of the communication device 700. The keypad 708 can be an integral part of a housing assembly of the communication device 700 or an independent device operably coupled thereto by a tethered wireline interface (such as a USB cable) or a wireless interface supporting for example Bluetooth. The keypad 708 can represent a numeric keypad commonly used by phones, and/or a QWERTY keypad with alphanumeric keys. The UI 704 can further include a display 710 such as monochrome or color LCD (Liquid Crystal Display), OLED (Organic Light Emitting Diode) or other suitable display technology for conveying images to an end user of the communication device 700. In an embodiment where the display 710 is touch-sensitive, a portion or all of the keypad 708 can be presented by way of the display 710 with navigation features.

The display 710 can use touch screen technology to also serve as a user interface for detecting user input. As a touch screen display, the communication device 700 can be adapted to present a user interface with graphical user interface (GUI) elements that can be selected by a user with a touch of a finger. The touch screen display 710 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 710 can be an integral part of the housing assembly of the communication device 700 or an independent device communicatively coupled thereto by a tethered wireline interface (such as a cable) or a wireless interface.

The UI 704 can also include an audio system 712 that utilizes audio technology for conveying low volume audio (such as audio heard in proximity of a human ear) and high volume audio (such as speakerphone for hands free operation). The audio system 712 can further include a microphone for receiving audible signals of an end user. The audio system 712 can also be used for voice recognition applications. The UI 704 can further include an image sensor 713 such as a charged coupled device (CCD) camera for capturing still or moving images.

The power supply 714 can utilize common power management technologies such as replaceable and rechargeable batteries, supply regulation technologies, and/or charging system technologies for supplying energy to the components of the communication device 700 to facilitate long-range or short-range portable applications. Alternatively, or in combination, the charging system can utilize external power sources such as DC power supplied over a physical interface such as a USB port or other suitable tethering technologies.

The location receiver 716 can utilize location technology such as a global positioning system (GPS) receiver capable of assisted GPS for identifying a location of the communication device 700 based on signals generated by a constellation of GPS satellites, which can be used for facilitating location services such as navigation. The motion sensor 718 can utilize motion sensing technology such as an accelerometer, a gyroscope, or other suitable motion sensing technology to detect motion of the communication device 700 in three-dimensional space. The orientation sensor 720 can utilize orientation sensing technology such as a magnetometer to detect the orientation of the communication device 700 (north, south, west, and east, as well as combined orientations in degrees, minutes, or other suitable orientation metrics).

The communication device 700 can use the transceiver 702 to also determine a proximity to a cellular, WiFi, Bluetooth, or other wireless access points by sensing techniques such as utilizing a received signal strength indicator (RSSI) and/or signal time of arrival (TOA) or time of flight (TOF) measurements. The controller 706 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 400.

Other components not shown in FIG. 7 can be used in one or more embodiments of the subject disclosure. For instance, the communication device 700 can include a reset button (not shown). The reset button can be used to reset the controller 706 of the communication device 700. In yet another embodiment, the communication device 700 can also include a factory default setting button positioned, for example, below a small hole in a housing assembly of the communication device 700 to force the communication device 700 to re-establish factory settings. In this embodiment, a user can use a protruding object such as a pen or paper clip tip to reach into the hole and depress the default setting button. The communication device 400 can also include a slot for adding or removing an identity module such as a Subscriber Identity Module (SIM) card. SIM cards can be used for identifying subscriber services, executing programs, storing subscriber data, and so forth.

The communication device 700 as described herein can operate with more or less of the circuit components shown in FIG. 7. These variant embodiments can be used in one or more embodiments of the subject disclosure.

The communication device 700 can be adapted to perform the functions of the media processor 406, the media devices 408, or the portable communication devices 416 of FIG. 4, as well as the IMS CDs 501-502 and PSTN CDs 503-505 of FIG. 5. It will be appreciated that the communication device 700 can also represent other devices that can operate in communication systems 400-500 of FIGS. 4-5 such as a gaming console and a media player.

The communication device 700 shown in FIG. 7 or portions thereof can serve as a representation of one or more of the devices of the system of FIGS. 1A-B, communication system 400, and communication system 500. In addition, the controller 706 can be adapted in various embodiments to perform the functions 462-466 and 572-574, respectively.

Upon reviewing the aforementioned embodiments, it would be evident to an artisan with ordinary skill in the art that said embodiments can be modified, reduced, or enhanced without departing from the scope of the claims described below. For example, other wireless discover techniques can be used to determine proximity, such as IEEE 802.11, e.g., WiFi, IEEE 802.15, e.g., Bluetooth, infrared, near field communication, optical, and the like. Functional features subject to enablement, disablement, and/or modification according to proximate devices and rules can include application services, operating system services, device specific services, and the like. For interrogator-transponder based discovery techniques, it is understood that transponders can be placed on one or more of the electronic devices, with the portable application management server and/or another device including an interrogator to determine proximity to the access management device. In at least some embodiments, a separately determined position, e.g., a GPS or other suitable navigation solution can be determined for the electronic devices and compared with a respective location (e.g., GPS) of the portable access management device to determine proximity therebetween. Other embodiments can be used in the subject disclosure.

It should be understood that devices described in the exemplary embodiments can be in communication with each other via various wireless and/or wired methodologies. The methodologies can be links that are described as coupled, connected and so forth, which can include unidirectional and/or bidirectional communication over wireless paths and/or wired paths that utilize one or more of various protocols or methodologies, where the coupling and/or connection can be direct (e.g., no intervening processing device) and/or indirect (e.g., an intermediary processing device such as a router).

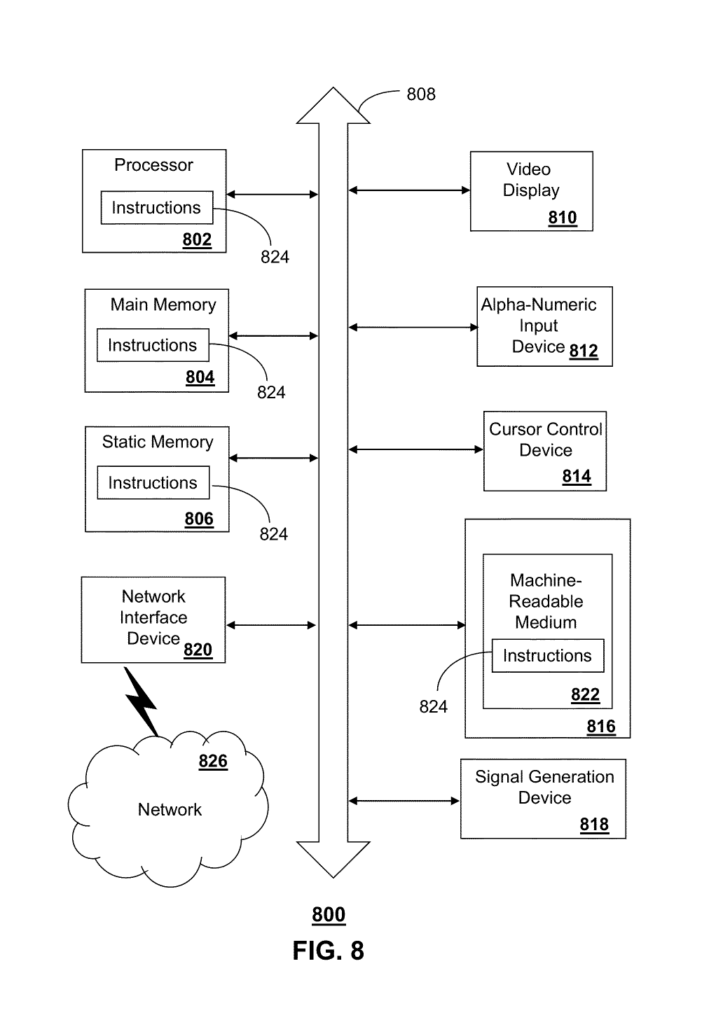

FIG. 8 depicts an exemplary diagrammatic representation of a machine in the form of a computer system 800 within which a set of instructions, when executed, may cause the machine to perform any one or more of the methods described above. One or more instances of the machine can operate, for example, as the access management server 430, the electronic devices, e.g., devices 104 and 106 (FIG. 1A), the portable access management devices 102, 452, 552, 652 and other devices of FIGS. 1A-B and 4-5. In some embodiments, the machine may be connected (e.g., using a network 826) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 800 may include a processor (or controller) 802 (e.g., a central processing unit (CPU), a graphics processing unit (GPU, or both), a main memory 804 and a static memory 806, which communicate with each other via a bus 808. The computer system 800 may further include a display unit 810 (e.g., a liquid crystal display (LCD), a flat panel, or a solid state display. The computer system 800 may include an input device 812 (e.g., a keyboard), a cursor control device 814 (e.g., a mouse), a disk drive unit 816, a signal generation device 818 (e.g., a speaker or remote control) and a network interface device 820. In distributed environments, the embodiments described in the subject disclosure can be adapted to utilize multiple display units 810 controlled by two or more computer systems 800. In this configuration, presentations described by the subject disclosure may in part be shown in a first of the display units 810, while the remaining portion is presented in a second of the display units 810.

The disk drive unit 816 may include a tangible computer-readable storage medium 822 on which is stored one or more sets of instructions (e.g., software 824) embodying any one or more of the methods or functions described herein, including those methods illustrated above. The instructions 824 may also reside, completely or at least partially, within the main memory 804, the static memory 806, and/or within the processor 802 during execution thereof by the computer system 800. The main memory 804 and the processor 802 also may constitute tangible computer-readable storage media.

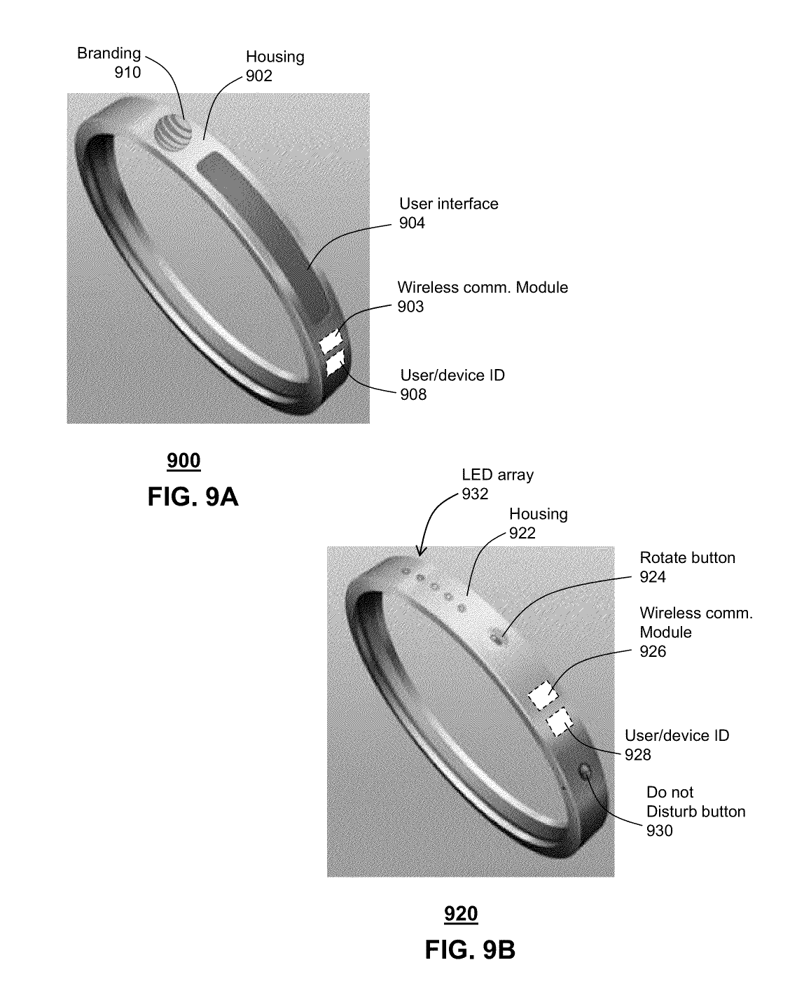

By way of non-limiting illustrative example, an embodiment of a portable access management device 900 is illustrated in FIG. 9A. The access management device 900 includes an annular housing 902 fashioned as a bracelet or wristband. The access management device 900 includes a wireless communication module 903 that can be arranged along an exposed surface of the housing 902, or embedded within the housing 902, e.g., under a transmissive cover, such as a radome or lens. A separate user or device ID 908 is also illustrated, understanding that the user or device ID 908 can be integrated together with the wireless communication module 903, e.g., as an RFID tag. The example access management device 900 includes a user interface 904 in the form of a touch or gesture pad. The apparently simplistic user interface 904 can be sophisticated in that it is configured to distinguish among a variety of gestures to distinguish among a variety of corresponding commands. By way of non-limiting example, such gestures can include a single tap, a multi tap, a single finger touch, a multi, e.g., two or three, finger touch, a swipe, e.g., from right to left and/or from left to right. It is understood that the device 900 can also include one or more user interface components, such as a microphone, speaker(s), light(s), and vibrator, e.g., to provide user feedback, e.g., a user alert.

In at least some embodiments, the housing is operable between an open and a closed position to facilitate a user wearing the device 900. For example, the housing 902 can include a hinge along a portion of the annulus and an opposing clasp to allow the housing to operate between open and closed configurations as in a clam shell. Alternatively or in addition, the device housing 902 can include a mechanism for adjustment, e.g., changing one or more of a size or a shape to facilitate comfortable and secure attachment to a user during periods of wear. At least one example includes an elastomeric portion, as in a portion of the annulus that can stretch resiliently to allow for passage over hand while constricting against a wrist for a snug, secure fit.

An alternative embodiment of a portable access management 920 device is illustrated in FIG. 9B. The device 920 includes a housing 922, a wireless communication module 926, e.g., with a user ID 928. The device 922 includes a different user interface including one or more buttons, such as a rotate button 924 and/or a do-not-disturb button 930. The rotate button 924 can be configured to reconfigure shared features among multiple electronic devices within wireless jurisdiction of the device 920. Such re-configuration can take the form of a rotation, e.g., from a first preferred device, e.g., the tablet computer 108 (FIG. 1B) to the mobile phone 106 (FIG. 1B) when both are within wireless jurisdiction of the device 920. An order of rotation among multiple electronic devices can be predetermined, e.g., by a network services provider, and/or configured by a user, e.g., in a user profile or otherwise during a configuration operation. Accordingly, a rotation order can be programmed or otherwise incorporated in to the rules 126 (FIG. 1B) applied in response to detected access management states and/or state changes.

The example embodiment illustrated in the device of 920 also includes an array of lights 932, e.g., LEDs, distributed along a visible portion of the housing. The LEDs of the array 932 can be lighted to indicate a number of electronic devices within wireless jurisdiction of the portable access management device 920. In the illustrative example of FIG. 1B, two such LEDs of the array 932 would be illuminated to indicate presence of the two devices 106, 108. Alternatively or in addition a quality of the illumination, such as an intensity and/or a color can be used as a means of identification. Namely, particular colors can be associated with particular devices, e.g., blue for mobile phone, green for tablet computer, so that when particular colors are illuminated, a user will know at once, which devices are available within the user's proximity. An intensity and or color can be used during the rotation procedure, e.g., showing a highlighted one of the LEDs for an active one of the electronic devices.

In one or more embodiments, a wearable RFID device is provided that is a gateway between a group of the user's devices and a cloud. The wearable device can manage connectivity including preferences for connection to a selected one of the user devices among the group of devices. The preferences for connectivity can be based on proximity of each of the devices to the wearable device (e.g., proximity to the user), as well as other user preferences which can be user-defined preferences or determined from monitored behavior of the user including devices typically utilized by the user for different types of communications, times of communication, and so forth. In one or more embodiments, the wearable device can also be used as a remote controller for one or more of the group of user devices, such as one or more of controlling song selection, muting a phone, ending a communication session, selecting a different device to receive an incoming communication (e.g., to override a user preference for selection of a device), and so forth. In one or more exemplary embodiments, the wearable device can manage the order of preference of user devices (e.g., mobile phone, tablet, car display) for incoming communications (e.g., calls, messages, emails). In one or more exemplary embodiments, the cloud can store user content, data and computing capabilities, and can be accessed by user devices that are functioning as thin client devices.

Dedicated hardware implementations including, but not limited to, application specific integrated circuits, programmable logic arrays and other hardware devices that can likewise be constructed to implement the methods described herein. Application specific integrated circuits and programmable logic array can use downloadable instructions for executing state machines and/or circuit configurations to implement embodiments of the subject disclosure. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the operations or methods described herein are intended for operation as software programs or instructions running on or executed by a computer processor or other computing device, and which may include other forms of instructions manifested as a state machine implemented with logic components in an application specific integrated circuit or field programmable gate array. Furthermore, software implementations (e.g., software programs, instructions, etc.) including, but not limited to, distributed processing or component/object distributed processing, parallel processing, or virtual machine processing can also be constructed to implement the methods described herein. It is further noted that a computing device such as a processor, a controller, a state machine or other suitable device for executing instructions to perform operations or methods may perform such operations directly or indirectly by way of one or more intermediate devices directed by the computing device.

While the tangible computer-readable storage medium 822 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the subject disclosure.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth, WiFi, Zigbee), and long-range communications (e.g., WiMAX, GSM, CDMA, LTE) can be used by computer system 800.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. The exemplary embodiments can include combinations of features and/or steps from multiple embodiments. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, can be used in the subject disclosure.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising:
facilitating, by a system comprising a processor, an association between a portable access management device and each of a first electronic device and a second electronic device, wherein the portable access management device comprises a radio frequency identifier, wherein the radio frequency identifier enables the first electronic device to detect that the portable access management device is in a vicinity of the first electronic device, wherein the radio frequency identifier enables the second electronic device to detect that the portable access management device is in the vicinity of the second electronic device, wherein the first electronic device and the second electronic device share a functional feature;
determining, by the system, that the first electronic device is in the vicinity of the portable access management device based on first presence information provided by the first electronic device to the system, wherein the first presence information is generated by the first electronic device responsive to the first electronic device detecting the radio frequency identifier of the portable access management device;
determining, by the system, that the second electronic device is not in the vicinity of the portable access management device responsive to not receiving information from the second electronic device indicating the second electronic device is in the vicinity of the portable access management device;
enabling, by the system, the functional feature of the first electronic device responsive to determining that the first electronic device is in the vicinity of the portable access management device; and
disabling, by the system, the functional feature of the second electronic device while the second electronic device is not in the vicinity of the portable access management device.

2. The method of claim 1, further comprising:
determining, by the system, that the second electronic device is in the vicinity of the portable access management device based on second presence information provided by the second electronic device to the system, wherein the second presence information is generated by the second electronic device responsive to the second electronic device detecting the radio frequency identifier of the portable access management device;
interpreting, by the system, a rule identifying an order of preference for enabling the functional feature of a select one of the first or the second electronic devices;
enabling, by the system, the functional feature of the select one of the first or second electronic devices responsive to determining that the second electronic device is in the vicinity of the portable access management device, and according to the order of preference identified by the rule; and
disabling, by the system, the functional feature of an unselected one of the first and second electronic devices responsive to determining that the second electronic device is in the vicinity of the portable access management device, and according to the order of preference identified by the rule.

3. The method of claim 2, wherein the first presence information comprises a first range of communication determined by the first electronic device based on signals received from the radio frequency identifier, wherein the second presence information comprises a second range of communication determined by the second electronic device based on signals received from the radio frequency identifier, wherein the portable access management device is carried by a person, and wherein the first electronic device and the second electronic device are selected from a group consisting of: a cellular telephone; a cordless telephone; a tablet computer; a portable computer; a desktop computer; a media player; a digital video recorder; a set-top box; a home entertainment system; a home automation system; a security system; and an automobile entertainment system.

4. The method of claim 2, further comprising:
receiving, by the system, input from equipment of a user indicative of the order of preference for enabling the functional feature of the select one of the first or the second electronic devices; and
generating, by the system, the rule identifying the order of preference responsive to receiving the input.

5. The method of claim 1, wherein the functional feature comprises an application selected from a group consisting of: cellular voice communications; cellular data communications; voice-over-IP communications; mobile instant messaging; video communications; streaming media; paging; voice mail; caller ID; news feeds; weather alerts; games; email; data backup; and web browsing.

6. The method of claim 5, further comprising accessing, by the system, the application via a network connection.

7. The method of claim 1, wherein the functional feature comprises a device feature selected from a group consisting of: a user alert; an audio alert; a visual alert; a video alert; a video presentation; an audio presentation; a microphone; a camera; and GPS.

8. A device, comprising:
a memory to store executable instructions; and
a processor coupled to the memory, wherein the processor, responsive to executing the instructions, performs operations comprising:
facilitating an association between a portable access management device and each of a first electronic device and a second electronic device, wherein the portable access management device comprises a radio frequency identifier, wherein the radio frequency identifier enables the first electronic device to detect that the portable access management device is in a vicinity of the first electronic device, wherein the radio frequency identifier enables the second electronic device to detect that the portable access management device is in the vicinity of the second electronic device, wherein the first electronic device and the second electronic device share a functional feature;
determining that the first electronic device is in the vicinity of the portable access management device based on first presence information provided by the first electronic device, wherein the first presence information is generated by the first electronic device responsive to the first electronic device detecting the radio frequency identifier of the portable access management device;
determining that the second electronic device is not in the vicinity of the portable access management device responsive to not receiving information from the second electronic device indicating the second electronic device is in the vicinity of the portable access management device;
enabling the functional feature of the first electronic device responsive to determining that the first electronic device is in the vicinity of the portable access management device; and
disabling the functional feature of the second electronic device responsive to determining that the second electronic device is not in the vicinity of the portable access management device.

9. The device of claim 8, wherein the operations further comprise:
determining that the second electronic device is in the vicinity of the portable access management device based on second presence information provided by the second electronic device, wherein the second presence information is generated by the second electronic device responsive to the second electronic device detecting the radio frequency identifier of the portable access management device;
interpreting a rule identifying an order of preference for enabling the functional feature of a select one of the first or the second electronic devices;
enabling the functional feature of the select one of the first or second electronic devices responsive to determining that the second electronic device is in the vicinity of the portable access management device, and according to the order of preference identified by the rule; and
disabling the functional feature of an unselected one of the first or second electronic devices responsive to determining that the second electronic device is in the vicinity of the portable access management device, and according to the order of preference identified by the rule.

10. The device of claim 9, wherein the first presence information comprises a first range of communication determined by the first electronic device based on signals received from the radio frequency identifier, wherein the second presence information comprises a second range of communication determined by the second electronic device based on signals received from the radio frequency identifier, wherein the portable access management device is carried by a person, and wherein the first electronic device and the second electronic device are selected from a group consisting of: a cellular telephone; a cordless telephone; a tablet computer; a portable computer; a desktop computer; a media player; a digital video recorder; a set-top box; a home entertainment system; a home automation system; a security system; and an automobile entertainment system.

11. The device of claim 9, wherein the operations further comprise:
receiving input from equipment of a user indicative of the order of preference for enabling the functional feature of the select one of the first or the second electronic devices; and
generating the rule identifying the order of preference responsive to receiving the input.

12. The device of claim 8, wherein the functional feature comprises an application selected from a group consisting of: cellular voice communications; cellular data communications; voice-over-IP communications; mobile instant messaging; video communications; streaming media; paging; voice mail; caller ID; news feeds; weather alerts; games; email; data backup; and web browsing.

13. The device of claim 12, wherein the processor further performs operations comprising accessing the application via a network connection.

14. The device of claim 8, wherein the functional feature comprises a device feature selected from a group consisting of: a user alert; an audio alert; a visual alert; a video alert; a video presentation; an audio presentation; a microphone; a camera; and GPS.

15. A machine-readable storage medium, comprising executable instructions which, responsive to being executed by a processor, cause the processor to perform operations comprising:
facilitating an association between a portable access management device and each of a first electronic device and a second electronic device, wherein the portable access management device comprises a wireless communication module, wherein the wireless communication module enables the first electronic device to detect that the portable access management device is in a vicinity of the first electronic device, wherein the wireless communication module enables the second electronic device to detect that the portable access management device is in the vicinity of the second electronic device, wherein the first electronic device and the second electronic device share a functional feature;
determining that the first electronic device is in the vicinity of the portable access management device based on first presence information provided by the first electronic device, wherein the first presence information is generated by the first electronic device responsive to the first electronic device wirelessly communicating with the portable access management device;
determining that the second electronic device is not in the vicinity of the portable access management device responsive to not receiving information from the second electronic device indicating the second electronic device is not in the vicinity of the portable access management device;
enabling the functional feature of the first electronic device responsive to determining the first electronic device is in the vicinity of the portable access management device; and
disabling the functional feature of the second electronic device responsive to determining that the second electronic device is not in the vicinity of the portable access management device.

16. The machine-readable storage medium of claim 15, wherein the processor further performs operations comprising:
determining that the second electronic device is in the vicinity of the portable access management device based on second presence information provided by the second electronic device, wherein the second presence information is generated by the second electronic device responsive to the second electronic device wirelessly communicating the portable access management device;
interpreting a rule identifying an order of preference for enabling the functional feature of a select one of the first or the second electronic devices;
enabling the functional feature of the select one of the first or second electronic devices responsive to determining the second electronic device is in the vicinity of the portable access management device, and according to the order of preference identified by the rule; and
disabling the functional feature of an unselected one of the first or second electronic devices responsive to determining that the second electronic device is in the vicinity of the portable access management device, and according to the order of preference identified by the rule.

17. The machine-readable storage medium of claim 16, wherein the first presence information comprises a first range of communication determined by the first electronic device based on signals received from the wireless communication module, wherein the second presence information comprises a second range of communication determined by the second electronic device based on signals received from the wireless communication module, wherein the portable access management device is carried by a person, and wherein the first electronic device and the second electronic device are selected from a group consisting of: a cellular telephone; a cordless telephone; a tablet computer; a portable computer; a desktop computer; a media player; a digital video recorder; a set-top box; a home entertainment system; a home automation system; a security system; an automobile entertainment system; and an automobile navigation system.

18. The machine-readable storage medium of claim 16, wherein the processor further performs operations comprising:
receiving input from equipment of a user indicative of the order of preference for enabling the functional feature of the select one of the first or the second electronic devices; and
generating the rule identifying the order of preference responsive to receiving the input.

19. The machine-readable storage medium of claim 15, wherein the functional feature comprises an application selected from a group consisting of: cellular voice communications; cellular data communications; voice-over-IP communications; mobile instant messaging; video communications; streaming media; paging; voice mail; caller ID; news feeds; weather alerts; games; email; data backup; and web browsing.

20. The machine-readable storage medium of claim 15, wherein the functional feature comprises a device feature selected from a group consisting of: a user alert; an audio alert; a visual alert; a video alert; a video presentation; an audio presentation; a microphone; a camera; and GPS.
